(19) United States
(12) Patent Application Publication
(10) Pub. No.: US 2015/0177125 A1
(43) Pub. Date: Jun. 25, 2015

(54) MEASUREMENT SYSTEM USING OPTICAL WAVEGUIDE

(71) Applicant: Kabushiki Kaisha Toshiba, Minato-ku (JP)

(72) Inventor: Shingo KASAI, Yokohama (JP)

(73) Assignee: Kabushiki Kaisha Toshiba, Minato-ku (JP)

(21) Appl. No.: 14/569,885

(22) Filed: Dec. 15, 2014

(30) Foreign Application Priority Data
Dec. 19, 2013 (JP) 2013-263091

(51) Int. Cl. G01N 21/17

(52) U.S. Cl. CPC G01N 21/17

(57) ABSTRACT

According to one embodiment, a measurement system which includes an optical waveguide, magnetic fine particles, a first magnetic field application unit, a second magnetic field application unit and a controller is provided. A first material specifically bonding with a target substance is immobilized on a surface of the optical waveguide. A second material specifically bonding with the target substance is immobilized on a surface of the magnetic fine particle. The first magnetic field application unit generates a magnetic field that moves the magnetic fine particles in a direction away from the optical waveguide. The second magnetic field application unit generates a magnetic field that moves the magnetic fine particles in a direction of approaching the optical waveguide. The controller controls the first magnetic field application unit to apply the magnetic field intermittently in a state where the second magnetic field application unit applies the magnetic field.

### CROSS-REFERENCE TO RELATED APPLICATION

This application is based upon and claims the benefit of priority from the prior Japanese Patent Application No. 2013-263091, filed on Dec. 19, 2013, the entire contents of which are incorporated herein by reference.

### FIELD

Embodiments described herein relate generally to a measurement system using an optical waveguide.

### BACKGROUND

A measurement system which measures target substances such as antigens by using an optical waveguide, antibodies, and magnetic fine particles is known. The antibodies bonds with the target substances specifically. In the measurement system, the antibodies are immobilized on the magnetic fine particles. The antibodies specifically bonding with the target substances are immobilized on the optical waveguide. The magnetic fine particles may be bonded with a surface of the optical waveguide through the target substances by an antigen-antibody reaction.

A magnetic field application unit which generates a magnetic field may be installed in the measurement system. The antigen-antibody reaction may be promoted by moving the magnetic fine particles to approach the optical waveguide by means of the magnetic field from the magnetic field application unit, or the detection sensitivity of the target substance may be improved by moving the magnetic fine particles which do not contribute to measurement away from the optical waveguide.

However, when a measurement item requiring higher detection sensitivity is considered, it is desirable that a new technique capable of obtaining high detection sensitivity in a shorter time is further developed.

### BRIEF DESCRIPTION OF THE DRAWINGS

FIG. 1 is a diagram illustrating a configuration of a measurement system using an optical waveguide according to a first embodiment.

FIG. 2 is a schematic diagram illustrating a configuration of a magnetic fine particle according to the first embodiment.

FIGS. 3A to 3G are diagrams illustrating steps of target substances contained in a test sample by the measurement system according to the first embodiment, respectively.

FIG. 4 is a diagram illustrating an example of a signal drop rate with respect to a stirring time of a solution.

FIG. 5 is a diagram illustrating a signal drop rate when different magnetic field application modes are used.

### DETAILED DESCRIPTION

According to one embodiment, a measurement system using an optical waveguide is provided. The measurement system includes an optical waveguide, magnetic fine particles, a first magnetic field application unit, a second magnetic field application unit and a controller. A first material specifically bonding with a target substance to be measured is immobilized on a surface of the optical waveguide. A second material specifically bonding with the target substance is immobilized on a surface of the magnetic fine particle.

The first magnetic field application unit generates a first magnetic field that moves the magnetic fine particles in a direction away from the optical waveguide. The second magnetic field application unit generates a second magnetic field that moves the magnetic fine particles in a direction of approaching the optical waveguide. The controller controls the first magnetic field application unit to apply the first magnetic field intermittently in a state where the second magnetic field application unit applies the second magnetic field.

Hereinafter, further embodiments will be described with reference to the drawings.

In the drawings, the same reference numerals denote the same or similar portions respectively.

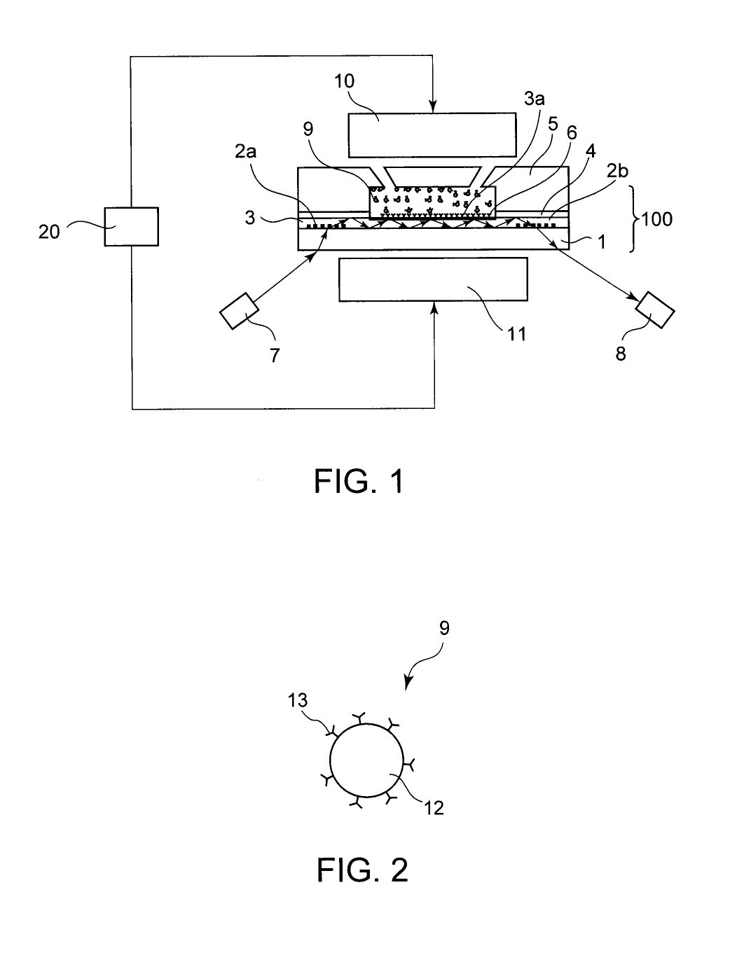

A first embodiment will be described with reference to FIG. 1. FIG. 1 is a diagram illustrating a configuration of a measurement system using an optical waveguide according to the embodiment.

The measurement system according to the embodiment is provided with a sensor chip 100 of an optical waveguide type, a light source 7, a light-receiving element 8, a first magnetic field application unit 10, a second magnetic field application unit 11, and a controller 20.

The sensor chip 100 is provided with a substrate 1, gratings 2a, 2b, a layer of an optical waveguide 3, a protective layer 4, a chamber 5, and magnetic fine particles 9. In the optical waveguide 3, a first material 6 specifically reacting with a target substance to be measured is immobilized on a surface of the optical waveguide 3. A second material 13 specifically reacting with the target substance is immobilized on the magnetic fine particle 9.

For example, a planar optical waveguide may be used as the optical waveguide 3. The optical waveguide 3 may be formed with a thermosetting resin or a photo-curing resin such as a phenol resin, an epoxy resin, or an acrylic resin or an alkali glass. More specifically, a resin which has a transparency with respect to predetermined light and which has a refractive index higher than that of the substrate 1 is desirable, particularly. The immobilization of the first materials 6 onto the optical waveguide 3 may be performed through hydrophobic interaction or chemical bonding with the surface of the optical waveguide 3.

For example, in a case where the target substance of the test sample is an antigen, an antibody (primary antibody) may be used as the first material 6. For example, in a case where the target substance of the test sample is an antigen, an antibody (secondary antibody) may be used as the second material 13.

The magnetic fine particles 9 are retained in a dispersed state on the optical waveguide 3 or are retained in a separate space, a container, a filter or a similar member (not shown in FIG. 1). The phrase “fine particles are retained in a dispersed state on the optical waveguide” means that the magnetic fine particles 9 are retained in a dispersed state indirectly or directly over the optical waveguide 3, namely, on the surface opposite to the surface which is in contact with the substrate 1. As the state that “fine particles are dispersed indirectly over the optical waveguide”, a state that the magnetic fine particles 9 are dispersed through a blocking layer on the surface of the optical waveguide 3 may be used. The blocking layer includes a water-soluble material such as polyvinyl alcohol, bovine serum albumin (BSA), polyethylene glycol, phospholipid polymer, gelatin, casein, or sugars (such as sucrose or trehalose), for example. As another example, a state that the magnetic fine particles 9 are arranged in an empty space above the optical waveguide 3 may be used. For example, a support plate (not shown) is arranged to face the optical waveguide 3, and the magnetic fine particles may be dispersed on the surface of the support plate facing the optical waveguide 3. In this case, it is desirable that the fine particles 9 are retained in a dry or semi-dry state. It is desirable that, when the fine particles are in contact with a dispersion medium such as a test sample solution, the fine particles are easily re-dispersed. Thus, the state that the fine particles are retained in the dry or semi-dry state needs not to be in a completely dispersed state. In a case that the fine particles are retained in a separate space or a container, a state of being dispersion solution or a state where the fine particles are precipitated in a dispersion medium may be used as well as a dry or semi-dry state.

FIG. 2 is a schematic diagram illustrating a configuration of a magnetic fine particle 9. The magnetic fine particle 9 is a fine particle where a second material 13 is immobilized on a surface of a fine particle 12. The fine particle 12 has a configuration where a magnetic body is surrounded by a macromolecular substance or a configuration where a surface of a core of a macromolecular substance is coated with a material containing magnetic particles, desirably. The fine particle 12 may be a magnetic particle itself, and in this case, it is desirable that the magnetic particle has a functional group which causes a material for identifying a measurement target to bond with a surface of the magnetic particle. As the magnetic material, various ferrites such as γ-Fe₂O₃ may be used. Particularly, a super-paramagnetic material which loses magnetism rapidly when a magnetic field is turned off is used desirably. A diameter of the fine particle 12 is in a range of 0.05 to 200 μm desirably, more preferably, in a range of 0.76 to 10 μm. Particularly, a fine particle having a diameter of 1.5 μm is used preferably. Since light absorption or scattering efficiency is increased by using the ranges of the diameter, it is possible to enhance detection sensitivity in the measurement system, which detects a target substances by using light.

The combination of the target substances and the first or second materials specifically bonding with the target substances is not limited to a combination of antigens and antibodies. For example, a combination of sugar and lectin, a combination of nucleotides chain and complementary nucleotide chains, a combination of ligands and receptors, etc. may be used.

A grating 2a on an incident-side and a grating 2b on an emitting-side are provided at both ends of a main surface of the optical waveguide 3. The substrate 1 may be an alkali-free glass. The gratings 2a, 2b are formed with a material having a refractive index higher than that of the substrate. The optical waveguide 3 is formed on the main surface of the substrate 1. The protective layer 4 covers the optical wave guide 3 and the gratings 2a, 2b. The protective layer 4 may be a resin film having a low refractive index. The protective layer 4 is opened so that a portion of the optical waveguide 3 positioned between the gratings 2a, 2b is exposed, and thus, a rectangular sensing area 3a is formed. The chamber 5 includes a liquid supply port and a liquid drain port and is formed on the protective layer 4 so as to surround the sensing area 3a which exposes the optical waveguide 3.

The first materials 6 are immobilized on the sensing area 3a of the surface of the optical waveguide 3, for example, through hydrophobilization treatment with a silane coupling agent. Alternatively, the first materials may be immobilized through chemical bonding by forming functional groups on the surface of the optical waveguide 3 and by making suitable linker molecules act. The second materials 13 are immobilized on the magnetic fine particle 9 through physical adsorption or chemical bonding by using a carboxyl group, an amino group, or the like, for example. The magnetic fine particles 9 on which the second materials 12 are immobilized are dispersed and retained on the surface of the optical waveguide 3 on which the first materials 6 are immobilized. The dispersion and retention of the magnetic fine particles 9 are implemented, for example, by applying slurry containing the magnetic fine particles 9 and water-soluble materials to the optical waveguide 3 or a surface of a member opposite to the surface of the optical waveguide 3 (not shown in FIG. 1) and by drying. Alternatively, the magnetic fine particles 9 may be dispersed in a liquid and the liquid may be retained in a separate space, a container, or the like (not shown in FIG. 1) other than the surface of the optical waveguide.

The light source 7 irradiates the above optical sensor chip with light. The light source 7 is a red LED, for example. A light incident from the light source 7 is diffracted by the incident-side grating 2a and reflected multiple times in the optical waveguide 3 to propagate. The light is diffracted by the grating 2b to be emitted. The light emitted from the grating 2b is received by the light-receiving element 8, and the light intensity is measured. The light-receiving element 8 is a photodiode, for example. A concentration of the target substances is measured by comparing an intensity of the incident light with an intensity of the emitted light to measure the absorbance of light.

The first magnetic field application unit 10 generates a magnetic field for moving the magnetic fine particles 9 in the direction away from the optical waveguide 3. The magnetic fine particles 9 are able to be moved by applying the magnetic field. The first magnetic field application unit 10 is arranged in a direction opposite to a direction where the optical waveguide 3 exists as viewed from the magnetic fine particles 9. In the embodiment, the first magnetic field application unit 10 is arranged in an upward direction in FIG. 1.

The second magnetic field application unit 11 generates a magnetic field for moving the magnetic fine particles 9 in a direction of approaching the optical waveguide 3. The second magnetic field application unit 11 is arranged in the direction where the optical waveguide 3 exists as viewed from the magnetic fine particles 9. In the embodiment, the second magnetic field application unit 11 is arranged in a downward direction in FIG. 1.

It is desirable that the magnetic field to be generated by the first magnetic field application unit 10 and the magnetic field to be generated by the second magnetic field application unit 11 have the same polarity. For example, when the magnetic field to be generated by the first magnetic field application unit 10 is formed by an S-pole and an N-pole in an order from above in FIG. 1, it is desirable that the magnetic field to be generated by the second magnetic field application unit 11 is set so as to be formed by an N-pole and an S-pole in an order from above in FIG. 1

The first magnetic field application unit 10 and the second magnetic field application unit 11 are, for example, magnets or electromagnets. It is desirable to use an electromagnet and a method of varying magnetic field strengths by controlling current in order to adjust the magnetic field strengths dynamically. However, the magnetic field strengths may be adjusted according to the strengths of the magnets themselves or a distance from a detection element using ferrite magnets etc. In a case of using the electromagnets, the magnetic field strengths may be adjusted by varying a current value applied to a coil.

The controller 20 controls timing of generating the magnetic fields and timings of stopping the generation of the magnetic fields in the respective first magnetic field application unit 10 and the second magnetic field application unit 11. The controller 20 may also control a time period of applying the magnetic fields. Due to the control, the first magnetic field application unit 10 and the second magnetic field application unit 11 are able to apply the magnetic fields at a predetermined time point or during time periods necessary to generate predetermined magnetic fields continuously.

Particularly, it is desirable that the controller 20 controls the first magnetic field application unit 10 to apply the magnetic field intermittently while allowing the second magnetic field application unit 11 to applying the magnetic field in a state where the magnetic fine particles 9 and the antigens exist on the sensing area 3a. By repeating starting of generation of the magnetic field and stopping of the magnetic field by the first magnetic field application unit 10, the magnetic fine particles 9 are greatly moved, and the test sample solution is stirred. In this case, the magnetic fine particles 9 operate as stirring bars. Due to the stirring, the antigens (target substances) are diffused into the test sample solution, and thus, the antigen-antibody reaction with the magnetic fine particles 9 is promoted so that it is possible to obtain high detection sensitivity in a shorter time. Particularly, in a case where the concentration of the target substances is low, it is possible to increase the detection sensitivity.

In this case, in order to enhance dispersibility of the magnetic fine particles 9, surfaces of the magnetic fine particles 9 may be charged with positive or negative charges. Alternatively, a dispersant such as a surfactant may be added to a dispersion medium of the magnetic fine particles 9. Due to this treatment, the test sample solution is further stirred so that it is possible to further enhance the detection sensitivity.

As a material of the magnetic fine particles 9, a super-paramagnetic material which loses magnetism rapidly when a magnetic field is turned off may be desirably used. By using such a material, even if the magnetic fine particles 9 are agglomerated by magnetization when the magnetic field is applied, the magnetic fine particles are able to be re-dispersed by turning off the magnetic field. In a case where the target substances do not exist in the sample solution, even if the magnetic field is applied, agglomerates of the magnetic fine particles 9 are produced and the magnetic fine particles are difficult to be peeled off or separated from the surface of the optical waveguide 3 so that it is possible to avoid cause of measurement error.

The controller 20 can adjust magnetic field strength to be applied by both of the first magnetic field application unit 10 and the second magnetic field application unit 11 or one of the units 10, 11. The magnetic field strength to be applied by both of the first magnetic field application unit 10 and the second magnetic field application unit 11 may be commonly adjusted, or the magnetic field strength may be independently adjusted. The magnetic field strength may be dynamically adjusted to be appropriate magnetic field strength by controlling the magnetic field strength at an arbitrary time.

Individual independent controllers 20a and 20b which control the first magnetic field application unit 10 and the second magnetic field application unit 11 respectively may exist in the controller 20. Alternatively, a single common controller 20 may independently control the first magnetic field application unit 10 and the second magnetic field application unit 11.

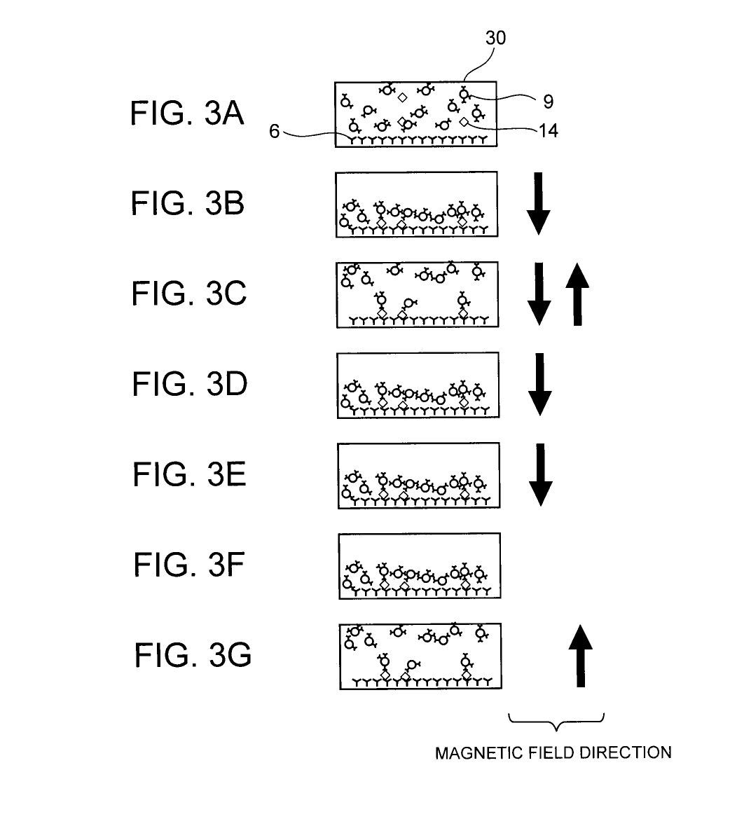

A method of measuring the target substances using the measurement system illustrated in FIG. 1 will be described with reference to FIGS. 3A to 3G.

As shown in FIGS. 1 and 3A, first materials 6 are immobilized on an optical waveguide 3. As shown in FIG. 3A, a test sample solution 30 is introduced above an optical waveguide 3 of FIG. 1. Magnetic fine particles 9 are re-dispersed in the test sample solution 30. In a case where the magnetic fine particles 9 are retained in a separate space, a container, or the like other than the optical waveguide 3, a mixed dispersion solution including a test sample solution and magnetic fine particles 9 is introduced. Alternatively, after a mixed dispersion solution including magnetic fine particles 9 is introduced, a test sample solution may be introduced to be mixed. In other words, the dispersion solution including the magnetic fine particles 9, and the sample solution may be separately introduced. As the introducing method, dropping or causing inflow may be used.

Subsequently, as illustrated in FIG. 3B, a magnetic field is applied by a second magnetic field application unit 11 in a precipitation direction as viewed from the magnetic fine particles 9, i.e. a direction to the optical waveguide 3 of FIG. 1, for example, in a downward direction in FIG. 1. Due to the application of the magnetic field, the magnetic fine particles 9 are attracted to the first materials 6, namely, to the optical waveguide 3 illustrated in FIG. 1.

Then, as illustrated in FIG. 3C, a magnetic field is applied by a first magnetic field application unit 10 in a direction different from the precipitation direction as viewed from the magnetic fine particles 9, for example, in an upward direction. As a result, the magnetic fine particles 9 which are adsorbed on a surface of the optical waveguide 3 without antigen-antibody reaction of target substances are moved in the direction different from the precipitation direction, for example, in the upward direction. At this time, the magnetic field from the second magnetic field application unit 11 continues to be applied.

As illustrated in FIG. 3D, after a certain time period passes from start of application of magnetic field by the first magnetic field application unit 10, the application of the magnetic field by the first magnetic field application unit 10 is stopped. Accordingly, only the magnetic field of the second magnetic field application unit 11 is applied, and the magnetic fine particles 9 are attracted again to the optical waveguide 3, as illustrated in FIG. 1.

Then, application of magnetic field by the first magnetic field application unit 10 as illustrated in FIG. 3C and stop of application of the magnetic field by the first magnetic field application unit 10 as illustrated in FIG. 3D are repeated predetermined times. For example, during a certain time period, with a certain interval, the application and stop of magnetic field by the first magnetic field application unit 10 can be performed. Alternatively, application of magnetic field by the first magnetic field application unit 10 during a predetermined time period and stop of application of magnetic field during a predetermined time period may be repeated up to a predetermined number of times. During the application and stop, magnetic field of the second magnetic field application unit 11 is continuously applied. Due to the application and stop of the magnetic field by the first magnetic field application unit 10, the magnetic fine particles 9 are attracted to the optical waveguide 3, moved in the direction away from the optical waveguide 3, or moved around in the test sample solution. In addition, in a case where the magnetic field is applied by both of the first magnetic field application unit 10 and the second magnetic field application unit 11, the magnetic fine particles 9 may also be moved in the direction parallel to the optical waveguide 3. Particularly, in a case where the first magnetic field application unit 10 and the second magnetic field application unit 11 generate magnetic fields which have the same polarity, the magnetic fine particles 9 are more greatly moved by repulsive force.

After the application and stop of magnetic field from the first magnetic field application unit 10 are repeated until the predetermined number of times ends or the predetermined time period ends, as illustrated in FIG. 3E, application of magnetic field from the first magnetic field application unit 10 is stopped, and only magnetic field from the second magnetic field application unit 11 is made to be in an applied state. Accordingly, the magnetic fine particles 9 are able to be attracted to the optical waveguide 3. At this time, the first materials 6 immobilized on the surface of the optical waveguide 3 such as primary antibodies and the second materials 13 immobilized on the magnetic fine particles 9 such as secondary antibodies are bonded by antigen-antibody reaction through the target substances such as antigens. As a result, the magnetic fine particles 9 are immobilized on the surface of the optical waveguide 3.

Then, as illustrated in FIG. 3F, the application of the magnetic field by the second magnetic field application unit 11 is stopped to make a state that any magnetic field is not applied. Due to the application of the magnetic field by only the second magnetic field application unit 11 as illustrated in FIG. 3E, driving force is exerted so that the magnetic fine particles 9 in the test sample solution are moved in the direction to the optical waveguide 3 illustrated in FIG. 1. As a result, much more number of the magnetic fine particles 9 is able to be attracted to the optical waveguide 3 in a shorter time. Accordingly, in this process, the first materials 6 such as primary antibodies immobilized on the surface of the optical waveguide 3 and the second materials 13 such as secondary antibodies immobilized on the magnetic fine particles 9 are also bonded by antigen-antibody reaction through the target substances such as antigens. Thus, the magnetic fine particles 9 are immobilized on the surface of the optical waveguide 3.

Then, as illustrated in FIG. 3G, a magnetic field is applied from the first magnetic field application unit 10 in the direction different from the precipitation direction as viewed from the magnetic fine particles 9, for example, in the upward direction. As a result, the magnetic fine particles 9 which are adsorbed onto the surface of the optical waveguide 3 are moved in the direction different from the precipitation direction, for example, in the upward direction without antigen-antibody reaction of the target substances, and are removed from the surface of the optical waveguide 3.

At this time, the magnetic field strength produced by the first magnetic field application unit 10 is set to an appropriate value so that some of the magnetic fine particles 9 which are immobilized on the surface of the optical waveguide 3 through the target substances by antigen-antibody reaction are not peeled off or not moved away. Only others of the magnetic fine particles 9 which are adsorbed on the surface of the optical waveguide 3 without antigen-antibody reaction of the target substances are able to be removed.

In this manner, the optimal magnetic field strength to be produced by the first magnetic field application unit 10 is a strength enough not to peel off some of the magnetic fine particles 9 contributing to measurement from the surface of the optical waveguide 3, and to peel off others of the magnetic fine particles 9 which cause noise in measurement from the surface of the optical waveguide 3 to a distance where the magnetic fine particles does not influence the measurement. As described above, it is desirable to use a method of adjusting magnetic field strength optimally with current by using an electromagnet. The magnetic field strength may be adjusted, using a ferrite magnet or the like, according to the strength of the magnet itself or the installation distance from a sensor chip. In the case of using the electromagnet, a coil is arranged at a site opposite to the precipitation direction i.e. the direction toward the optical waveguide 3 as viewed from the magnetic fine particles 9, and a current is applied to the coil. The magnetic field strength may be adjusted by changing the current value.

In order to adjust the magnetic field strength optimally, the measurement system according to the embodiment may be configured to further include a magnetic field controller (not shown in FIG. 1). The above-described control is performed by the magnetic field controller so that it is possible to adjust the magnetic field strength to a strength enough not to peel off some of the magnetic fine particles 9 contributing to measurement from the surface of the optical waveguide 3, and to peel off others of the magnetic fine particles 9 which cause noise in measurement from the surface of the optical waveguide 3 to the distance where the magnetic fine particles are not to influence the measurement. In a case of adjusting magnetic field strength at an arbitrary time, it is possible to control the magnetic field dynamically by adjusting the magnetic field strength by the magnetic field controller.

The concentration of antigens in a test sample solution can be detected by measuring a difference of detection signal intensities received by the light-receiving element 8. More specifically, in FIG. 1, an LED light from a light source 7 is incident from the grating 2a on a incident-side to the optical waveguide 3 and is reflected multiple time in the optical waveguide 3 to propagate so that evanescent light is generated in the vicinity of a surface of the optical waveguide 3 i.e. an exposed surface of a sensing area. When a mixed dispersion solution of a test sample solution and magnetic fine particles 9 is introduced on the sensing area in the state, the fine particles 9 are precipitated or attracted by the magnetic field immediately after introduction of the mixed dispersion solution, from the state of FIG. 3A. Accordingly, as illustrated in FIGS. 3B to 3F, the fine particles 9 reach the vicinity of the surface of the optical waveguide 3, namely, an evanescent light region. Since the fine particles 9 are involved in the absorption or scattering the evanescent light, the intensity of totally reflected light is attenuated. As a result, when an LED light emitted from the grating 2b is received by the light-receiving element 8, the intensity of the emitted LED light is decreased with elapse of time due to the influence of the bonded fine particles 9. Then, some of the magnetic fine particles which are adsorbed on the optical waveguide 3 without antigen-antibody reaction are peeled off by the first magnetic field application unit 10. When the magnetic fine particles reach a region other than the evanescent light (FIG. 3G), the intensity of the received light is recovered up to a predetermined value. By comparing the intensity of the light received at the time with the intensity of the light received in the state of FIG. 3A, namely, the intensity of the received light immediately after introduction of the mixed dispersion solution, the intensity of the received light can be represented numerically as a drop rate, for example.

The drop rate of the intensity of the LED light received by the light-receiving element 8 depends on the number of fine particles 9 bonding with the surface of the optical waveguide 3 mainly by the antigen-antibody reaction or the like. Namely, the drop rate is proportional to the concentration of antigens in a test sample solution involved in antigen-antibody reaction. Accordingly, by obtaining a varying curve of the intensity of the LED light in the test sample solution where the concentration of antigens with elapse of time is known, and by obtaining a drop rate of the intensity of the LED light in a predetermined time period after application of the magnetic field in an upward direction of the curve, a calibration line representing a relationship between the concentration of the antigens and a drop rate of the intensity of the LED light is produced in advance. By obtaining a drop rate of the intensity of the LED light at a predetermined time from a varying curve of a time and an intensity of the LED light measured by the above method with respect to a test sample solution where the concentration of antigens is unknown, and by comparing the drop rate of the intensity of the LED light with the calibration line, it is possible to measure the concentration of the antigens in the test sample solution.

Hereinafter, an example where measurement according to the embodiment was performed in an experiment will be described. In the example, detailed numerical values and materials are exemplary ones, and the present invention is not limited to the numerical values or the materials.

In the experiment, influenza antigens were used as the target substances. Two test sample solutions having respective kinds of concentration of 6000-times-diluted antigens (6 k) and 60000-times-diluted antigens (60 k) were produced by diluting an undiluted solution containing influenza virus with a surfactant solution for exposing the antigens. The experiment was performed on three kinds of test sample solutions totally including the two test sample solutions and a blank solution containing no antigen. A dispersion solution of magnetic fine particles on which antibodies were immobilized was produced separately. Electromagnet coils were used as the first magnetic field application unit 10 and the second magnetic field application unit 11.

At the time of measurement, a sensor chip 100 of FIG. 1 is attached onto a black ABS resin block using a light-shielding double-sided tape, and is set in a measuring instrument. A dispersion solution containing magnetic fine particles and each of the above-described sample solutions were mixed in a microtube to make a mixture solution, and, after pipetting was performed 20 times, the mixture solution was fed into the block. The time immediately after feeding of the mixture solution was assumed to be zero (0) second. For 2 minutes after 5 seconds, a magnetic field was applied by flowing a current in the second magnetic field application unit 11 so that the magnetic fine particles were attracted to a surface of the optical waveguide 3. After application of the magnetic field was stopped for 5 minutes by turning off the power of the second magnetic field application unit 11, a magnetic field was applied by flowing a current in the first magnetic field application unit 10 so that unbound magnetic fine particles were moved away from the surface of the optical waveguide 3. When the signal intensity immediately after feeding of the mixture solution was set to 100%, the signal drop rate of the signal intensity occurring 30 seconds after application of the magnetic field by the first magnetic field application unit 10 to the signal intensity immediately after feeding of the mixture solution was used as an indicator of detection sensitivity of the target substances.

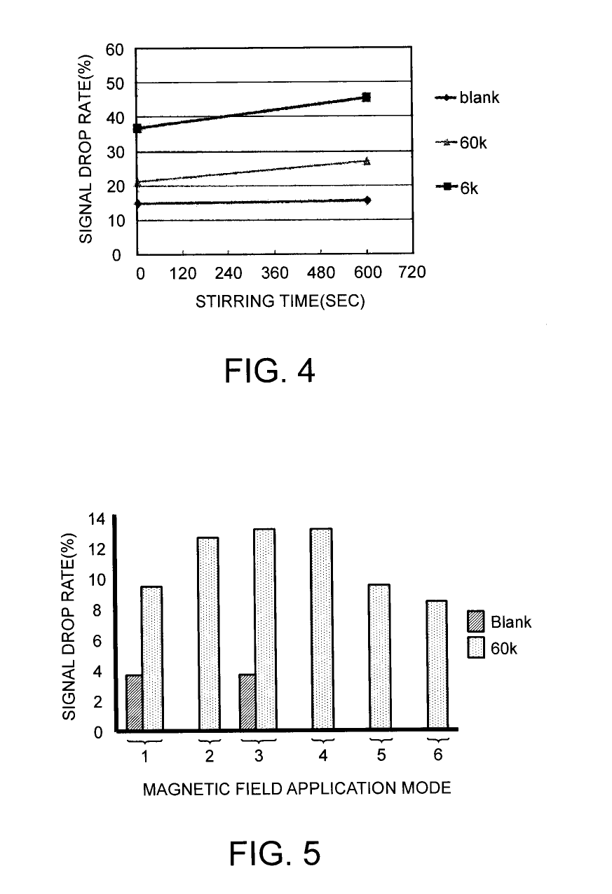

FIG. 4 illustrates an example of the signal drop rate with respect to a stirring time of the solution. In the above experiment, for the purpose of reacting the magnetic fine particles with the antigens sufficiently, after the magnetic fine particles and the antigens were mixed to prepare the mixture solution, and then, the mixture solution were stirred for 10 minutes with a vortex and dropped to the chip. Subsequently, signal drop rates were measured. As illustrated in FIG. 4, while the signal drop rate of the blank solution was constant at about 16% irrespective of the stirring time, the signal drop rate of the 60 k solution was increased from 20% to 27%, and the signal drop rate of the 6 k solution was increased from 36% to 45% according to the increase of the respective stirring times. It is considered from these changes that the antibodies and the antigens were bonded enough through sufficient stirring of the mixture solutions. Consequently, the efficiency of using the antigens was increased, and the detection sensitivity of the target substances was raised. It is also considered that each of the mixture solutions was stirred by moving the magnetic fine particles by magnetic field after magnetic fine particles and each of the sample solutions were droped on to the sensor chip 100 so that the efficiency of using the antigens was raised.

The drop rates of the detection signal intensity in cases of performing measuring methods under different magnetic field application modes were measured. FIG. 5 illustrates signal drop rates obtained using the measuring methods under the different magnetic field application modes. The measuring methods used in the experiment are the following six methods (1) to (6). The phrase “upper magnetic field is ON” means that magnetic field is applied by the first magnetic field application unit 10, and the phrase “upper magnetic field is OFF” means that application of magnetic field by the first magnetic field application unit 10 is stopped. Similarly, the phrase “lower magnetic field is ON” denotes that the magnetic field is applied by the second magnetic field application unit 11, and the phrase “lower magnetic field is OFF” means that application of magnetic field by the second magnetic field application unit 11 is stopped.

(1) Method of Measuring Reference Value

Sequentially, the lower magnetic field is turned ON at the same time of dropping the mixture solution, the lower magnetic field is applied for 2 minutes, the lower magnetic field is turned OFF, natural precipitation is performed, and then only the upper magnetic field is turned ON.

This is a method where stirring of a mixture solution by turning ON and OFF the magnetic fields is not performed but the magnetic fine particles 9 are attracted to the optical waveguide 3 to promote bonding, and then the magnetic fine particles 9 which are to be noise components are moved away from the optical waveguide 3.

(2) First Measuring Method According to the Embodiment (Stirring Time: 1 Minute)

Sequentially, the lower magnetic field is turned ON at the same time of dropping the solution, the cycle where the upper magnetic field is ON (for 2 seconds) and the upper magnetic field is OFF (for 2 seconds) is performed for 1 minute to stir the solution in a state where the lower magnetic field is applied, the upper magnetic field is turned OFF, and only the lower magnetic field is applied, all the magnetic fields are turned OFF and natural precipitation is performed, and only the upper magnetic field is turned ON. This is a method where the solution is stirred by turning ON and OFF the upper magnetic field in a state where the lower magnetic field is applied.

(3) Second Measuring Method According to the Embodiment (Stirring Time: 2 Minutes)

Sequentially, the lower magnetic field is turned ON at the same time of dropping the solution, the cycle where the upper magnetic field is ON (for 2 seconds) and the upper magnetic field is OFF (for 2 seconds) is performed for 2 minutes to stir the solution in a state where the lower magnetic field is applied, the upper magnetic field is turned OFF and only the lower magnetic field is applied, all the magnetic fields are turned OFF and natural precipitation is performed, and only the upper magnetic field is turned ON.

This is a method where the solution is stirred by turning ON and OFF the upper magnetic field in a state where the lower magnetic field is applied.

(4) Third Measuring Method According to the Embodiment (Stirring Time: 3 Minutes)

Sequentially, the lower magnetic field is turned ON at the same time of dropping the solution, the cycle where the upper magnetic field is ON (for 2 seconds) and the upper magnetic field is OFF (for 2 seconds) is performed for 3 minutes to stir the solution in a state where the lower magnetic field is applied, the upper magnetic field is turned OFF, only the lower magnetic field is applied, all the magnetic fields are turned OFF and natural precipitation is performed, and only the upper magnetic field is turned ON.

This is a method where the solution is stirred by turning ON and OFF the upper magnetic field in a state where the lower magnetic field is applied.

(5) First Measuring Method According to Comparative Example

Sequentially, the solution is dropped, the lower magnetic field and the upper magnetic field are alternately applied for 2 seconds for an period of 2 minutes, the upper magnetic field is turned OFF, and only the lower magnetic field is applied, all the magnetic fields are turned OFF and natural precipitation is performed, and only the upper magnetic field is turned ON.

This is a method where the upper magnetic field and the lower magnetic field are alternately applied.

(6) Second Measuring Method According to Comparative Example

Sequentially, the solution is dropped, it is performed for an period of 2 minutes that the lower magnetic field and the upper magnetic field are alternately applied for 2 seconds with all magnetic fields turned OFF for 2 seconds between the applications, the upper magnetic field is turned OFF, and only the lower magnetic field is applied, all the magnetic fields are turned OFF and natural precipitation is performed, and only the upper magnetic field is turned ON.

This is a method where the upper magnetic field and the lower magnetic field are alternately applied.

From FIG. 5, in the above method (1) for measuring a reference value, the signal drop rate was about 3.5% in the case of using the blank solution, and the signal drop rate was about 9.3% in the case of using the 60 k solution. On the other hand, in the methods (5) and (6) according to Comparative Examples, the signal drop rates were about 9.5% and 8.3% in the case of using the 60 k solution, respectively.

On the contrary, in the first to third measuring methods (2) to (4) according to the embodiment, the signal drop rates were increased up to a range of 12.7% to 13.3% in the case of using the 60 k solution.

It can be understood from the results that the signal drop rate is large, and the detection sensitivity of the target substances is high in the cases of (2) to (4) according to the embodiment where stirring is performed, in comparison with the case such as the measurement of the reference value of the method (1) where stirring is not performed. It is considered that this is because the magnetic fine particles operate as stirring bars, and the reaction of the antigens and the antibodies in the solution is promoted in the cases of (2) to (4) according to the embodiment. It is understood that it is possible to react much more number of the antigens in the methods (2) to (4) according to the embodiment, since the lower magnetic field is always applied to attract the magnetic fine particles to the optical waveguide 3 so as to promote bonding and the solution is stirred by turning ON and OFF the upper magnetic field to disperse most of the antigens in the solution.

With respect the second method (3) according to the embodiment, the signal drop rate was measured to be about 3.8% in the case of using the blank solution. This is substantially equivalent to the measurement value of the blank solution in the measurement of the reference value. Accordingly, it can be confirmed that the agglomerate of the magnetic fine particles is not generated by the application of the magnetic field and that the detection sensitivity of the target substances was raised by increase of efficiency of using the antigens due to movement of the magnetic fine particles.

Similarly to Comparative Examples of (5) and (6), it can be understood that the effect of the stirring cannot be sufficiently obtained even if the upper magnetic field and the lower magnetic field are alternately applied, and that increase of detection sensitivity cannot be obtained in comparison with the measurement of the reference value in the method (1). It is considered that this is because, in the state where the magnetic field is applied to only one side, only the lines of magnetic force in the direction perpendicular to the surface of the sensor chip are generated and the magnetic fine particles are moved along the lines of magnetic force so that the amount of the movement is small and the efficiency of the reaction with the antigens which are not moved by the magnetic field is not increased.

On the contrary, it is considered that, in the cases of the methods (2) to (4) according to the embodiment where the stirring is performed, the solution is stirred while the magnetic field having the same polarity is simultaneously applied so that the lines of magnetic force of the upper magnetic field and the lines of magnetic force of the lower magnetic field repulse each other and thus the amount of the movement of the magnetic fine particles is large and the effect of the stirring can be sufficiently obtained.

As described above, it was confirmed that the solution was stirred by turning ON/OFF the upper magnetic field while applying the lower magnetic field so that the detection sensitivity of the target substances was increased.

According to the embodiment, while the magnetic field is applied by the second magnetic field application unit 11, application and stop of magnetic field by the first magnetic field application unit 10 is repeated so that the magnetic fine particles 9 are able to be attracted to the optical waveguide 3 and the magnetic fine particles 9 are able to be moved. Accordingly, a test sample solution can be stirred to promote antigen-antibody reaction, and Much more number of antigens can be used to allow much more number of magnetic fine particles 9 to bond with a surface of the optical waveguide. Since the rate of contribution of the target substances to bonding the magnetic fine particles 9 and the optical waveguide 3 can be increased, it is possible to obtain higher detection sensitivity. As a result, it is possible to shorten a time required for measuring the target substances. According to the embodiment, even in a case where the concentration of the target substances is low, the antigens are able to be effectively measured and utilized so that it is possible to effectively increase the detection sensitivity particularly in a case where the concentration of the target substances is low.

According to the embodiment, since the magnetic field by the first magnetic field application unit 10 and the magnetic field by the second magnetic field application unit 11 are set to have the same polarity, the lines of magnetic force occur in the direction of repulsion, and thus, the amount of movement of the magnetic fine particles 9 is increased so that the solution is further stirred. Accordingly, it is possible to further increase the detection sensitivity.

In addition, in order to increase the dispersibility of the magnetic fine particles 9, the surfaces of the magnetic fine particles 9 may be charged with positive or negative charges. Alternatively, a dispersant such as a surfactant may be added to a dispersion medium of the magnetic fine particles 9. By the treatment, a test sample solution is further stirred so that it is possible to further increase the detection sensitivity.

After the stirring of the solution by application and stop of magnetic field, the magnetic field is applied to the magnetic fine particles in a direction different from a precipitation direction so that it is possible to peel off the magnetic fine particles adsorbed on the optical waveguide which are to be noise without antigen-antibody reaction, from the optical waveguide Accordingly, it is possible to measure the absorbance caused by only the magnetic fine particles which are bonded with on a surface of the optical waveguide through antigens by antigen-antibody reaction so that it is possible to reduce the error of the detection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement system using an optical waveguide comprising:
an optical waveguide on a surface of which a first material specifically bonding with a target substance to be measured is immobilized;
magnetic fine particles on which a second material specifically bonding with the target substance is immobilized, the magnetic fine particles having magnetism;
a first magnetic field application unit which generates a first magnetic field that moves the magnetic fine particles in a direction away from the optical waveguide;
a second magnetic field application unit which generates a second magnetic field that moves the magnetic fine particles in a direction of approaching the optical waveguide; and
a controller which controls the first magnetic field application unit so as to apply the magnetic field of the first magnetic field application unit intermittently in a state where the second magnetic field application unit applies the magnetic field.

2. The system according to claim 1, wherein the first magnetic field application unit and the second magnetic field application unit generate magnetic fields which have the same polarity as the first and the second magnetic fields.

3. The system according to claim 1, wherein the first magnetic field application unit applies the first magnetic field by using an altenating current.

4. The system according to claim 2, wherein the first magnetic field application unit applies the magnetic field by using an altenating current.

5. The system according to claim 1, wherein the controller controls the first magnetic field application unit so as to stop application of the first magnetic field after the first magnetic field application unit periodically applies the first magnetic field in a state where the second magnetic field application unit applies the second magnetic field.

6. The system according to claim 2, wherein the controller controls the first magnetic field application unit so as to stop application of the first magnetic field after the first magnetic field application unit periodically applies the first magnetic field in a state where the second magnetic field application unit applies the second magnetic field.

7. The system according to claim 3, wherein the controller controls the first magnetic field application unit so as to stop application of the first magnetic field after the first magnetic field application unit periodically applies the first magnetic field in a state where the second magnetic field application unit applies the second magnetic field.

8. The system according to claim 4, wherein the controller controls the first magnetic field application unit so as to stop application of the first magnetic field after the first magnetic field application unit periodically applies the first magnetic field in a state where the second magnetic field application unit applies the second magnetic field.

9. The system according to claim 1, wherein the controller controls the second magnetic field application unit so as to stop the application of the second magnetic field and controls the first magnetic field application unit so as to apply the first magnetic field, after the first magnetic field application unit periodically applies the first magnetic field in a state where the second magnetic field application unit applies the second magnetic field.

10. The system according to claim 2, wherein the controller controls the second magnetic field application unit so as to stop the application of the second magnetic field and controls the first magnetic field application unit so as to apply the first magnetic field, after the first magnetic field application unit periodically applies the first magnetic field in a state where the second magnetic field application unit applies the second magnetic field.

11. The system according to claim 3, wherein the controller controls the second magnetic field application unit so as to stop the application of the second magnetic field and controls the first magnetic field application unit so as to apply the first magnetic field, after the first magnetic field application unit periodically applies the first magnetic field in a state where the second magnetic field application unit applies the second magnetic field.

12. The system according to claim 4, wherein the controller controls the second magnetic field application unit so as to stop the application of the second magnetic field and controls the first magnetic field application unit so as to apply the first magnetic field, after the first magnetic field application unit periodically applies the first magnetic field in a state where the second magnetic field application unit applies the second magnetic field.

13. The system according to claim 5, wherein the controller controls the second magnetic field application unit so as to stop the application of the second magnetic field and controls the first magnetic field application unit so as to apply the first magnetic field, after the first magnetic field application unit periodically applies the first magnetic field in a state where the second magnetic field application unit applies the second magnetic field.
